(19) United States
(12) Patent Application Publication
(10) Pub. No.: US 2026/0107041 A1
(43) Pub. Date: Apr. 16, 2026

(54) VIDEO LIST PROCESSING METHOD, DEVICE, MEDIUM

(71) Applicant: Beijing Zitiao Network Technology Co., Ltd., Beijing (CN)

(72) Inventors: Boyu HOU, Beijing (CN); Juguang LIU, Beijing (CN); Zongshao CHE, Beijing (CN); Yuan GE, Beijing (CN)

(21) Appl. No.: 19/350,950

(22) Filed: Oct. 6, 2025

(30) Foreign Application Priority Data
Oct. 10, 2024 (CN) 202411412961.3

(51) Int. Cl. H04N 21/482; H04N 21/81; H04N 21/8547

(52) U.S. Cl. CPC H04N 21/4825; H04N 21/8146; H04N 21/8547

(57) ABSTRACT

Provided are a video list processing method, apparatus, device, medium and program product. The method includes: obtaining target content corresponding to a target object, the target content being used to generate at least one target video corresponding to the target object; displaying a placeholder identifier corresponding to the at least one target video through a video list, generating at least one initial video of the target object according to the target content, and replacing a corresponding placeholder identifier in the video list with a successfully generated initial video; generating an effect material of the at least one initial video according to the target content, and superimposing the effect material on the initial video in the video list according to preset layout information, so as to obtain the target video.

### CROSS-REFERENCE TO RELATED APPLICATION

The present disclosure claims priority of the Chinese Patent Application No. 202411412961.3 filed on October 10, 2024, the disclosure of which is incorporated herein by reference in its entirety as part of the present application.

### TECHNICAL FIELD

Embodiments of the present disclosure relates to the computer technology, and in particular, to a video list processing method, apparatus, device, medium and program product.

### BACKGROUND

The time consumed by video generation is much longer than the time consumed by generating images and text. If multiple videos are generated for a specific material, only after all the videos in the video list are generated can the video list be displayed for a user to view the video effect. In this way, it is easy to block the display of the entire video list because of a single slowly-generated video, which increases the time consumption of the process of other videos from being generated to being visible. During this process, the user cannot perform other operations, resulting in poor user experience.

### SUMMARY

The embodiments of the present disclosure provides a video list processing method, apparatus, device, medium and program product, which can shorten the time consumption of the process from video generation to video visibility and improve the user experience.

In a first aspect, the embodiments of the present disclosure provide a video list processing method, including:

obtaining target content corresponding to a target object, the target content being used to generate at least one target video corresponding to the target object;

displaying a placeholder identifier corresponding to the at least one target video through a video list, generating at least one initial video of the target object according to the target content, and replacing a corresponding placeholder identifier in the video list with a successfully generated initial video; and

generating an effect material of the at least one initial video according to the target content, and superimposing the effect material on the initial video in the video list according to preset layout information, so as to obtain the target video.

In a second aspect, the embodiments of the present disclosure further provide a video list processing apparatus, including:

a content obtaining module, configured to obtain target content corresponding to a target object, the target content being used to generate at least one target video corresponding to the target object;

a list displaying module, configured to display a placeholder identifier corresponding to the at least one target video through a video list, generate at least one initial video of the target object according to the target content, and replace a corresponding placeholder identifier in the video list with a successfully generated initial video; and

a video superimposing module, configured to generate an effect material of the at least one initial video according to the target content, and superimpose the effect material on the initial video in the video list according to preset layout information, so as to obtain the target video.

In a third aspect, the embodiments of the present disclosure further provide an electronic device, including:

one or more processors; and

a storage apparatus, configured to store one or more programs;

when the one or more programs are executed by the one or more processors, the one or more processors are caused to implement the video list processing method as described in any of the embodiments of the present disclosure.

In a fourth aspect, the embodiments of the present disclosure further provide a storage medium containing computer-executable instructions; the computer-executable instructions, when executed by a computer processor, are used to execute the video list processing method as described in any of the embodiments of the present disclosure.

In a fifth aspect, the embodiments of the present disclosure provide a computer program product, including a computer program, the computer program, when executed by a processor, implements the video list processing method as described in any of the embodiments of the present disclosure.

In the video list processing method, apparatus, device, medium and program product provided by the embodiments of the present disclosure, the target content of the target object is obtained for generating at least one target video corresponding to the target object; the placeholder identifier corresponding to the at least one target video is displayed through the video list; at least one initial video of the target object is firstly generated according to the target content, and a corresponding placeholder identifier in the video list is replaced by the successfully generated initial video, which can avoid the problem of blocking the display of the entire video list due to a single slowly-generated video, and shorten the time consumption from video generation to video visibility. In the process of generating and displaying the initial video, concurrently, the effect material of at least one initial video is generated according to the target content, and the successfully generated effect material is superimposed on the initial video according to the preset layout information, so as to obtain the target video. In the embodiment of the present disclosure, an initial video without the effect material is firstly generated, and the initial video is displayed in a video list, and then the successfully generated effect material is superimposed on the initial video in the form of plug-in, so as to realize progressive enhancement.

### BRIEF DESCRIPTION OF DRAWINGS

In combination with accompanying drawings and with reference to the following description of embodiments, the above and other features, advantages and aspects of the embodiments of the present disclosure will become more clearly. Throughout the accompanying drawings, a same or similar reference numeral represents a same or similar element. It should be understood that the accompanying drawings are illustrative and that the component and the element are not necessarily drawn to scale.

FIG. 1 is a schematic flowchart of a video list processing method provided by an embodiment of the present disclosure;

FIG. 2 is a schematic diagram of a video list provided by an embodiment of the present disclosure;

FIG. 3 is a schematic diagram of preset layout information provided by an embodiment of the present disclosure;

FIG. 4 is a flowchart of another video list processing method provided by an embodiment of the present disclosure;

FIG. 5 is a schematic diagram of a video rendering process provided by an embodiment of the present disclosure;

FIG. 6 is a schematic structural diagram of a video list processing apparatus provided by an embodiment of the present disclosure; and

FIG. 7 is a schematic structural diagram of an electronic device provided by an embodiment of the present disclosure.

### DETAILED DESCRIPTION

Hereinafter, the embodiments of the present disclosure will be described in more details with reference to the accompanying drawings. Although some embodiments of the present disclosure are illustrated in the drawings, it is to be understood that the present disclosure may be implemented through various forms, and may not be interpreted as being limited to the embodiments illustrated herein. On the contrary, these embodiments are only intended for a more thorough and complete understanding of the present disclosure. It is to be understood that the accompanying drawings and embodiments of the present disclosure are only for the purpose of illustration and are not intended to limit the protection scope of the present disclosure.

It should be understood that, steps described in the embodiments of the present disclosure may be performed in different orders and/or performed in parallel. In addition, the method embodiments may include additional steps and/or omit performing of illustrated steps. The scope of the present disclosure is not limited thereto.

The term “including” and variations thereof adopted herein is inclusive, that is “including but not limited to”. The term “based on” means “at least partially based on”. The term “an embodiment” means “at least one embodiment”, and the term “another embodiment” means “at least another embodiment”. The term “some embodiment” means “at least some embodiments”. Definitions of other terms are provided below.

It should be noted that, the terms “first,” “second,” etc., mentioned in the present disclosure are only used to distinguish different apparatuses, modules or units, rather than limit an order or interdependence of functions performed by these apparatuses, modules or units.

It should be noted that, the terms “one” and “a plurality” mentioned in the present disclosure are illustrative rather than restrictive, and should be understood as “one or more” by those skilled in the art, unless otherwise explicitly illustrated in the context.

Names of messages or information exchanged among multiple apparatuses in the embodiments of the present disclosure are merely used for illustrative purposes, and are not used to limit the scope of these messages or information.

It is to be understood that before using technical solutions disclosed in various embodiments of the present disclosure, a user should be notified of the type, scope of use, use scene and the like of personal information involved in the present disclosure in an appropriate manner according to relevant laws and regulations, and authorization from the user should be acquired.

For example, in response to receiving an active request from a user, prompt information is sent to the user to explicitly remind the user that the requested operation requires acquisition and use of personal information of the user. Therefore, the user can independently choose, according to the prompt information, whether to provide personal information to software or hardware, such as an electronic device, an application program, a server, or a storage medium, etc., for executing operations of the technical solution of the present disclosure.

In an optional but non-limiting embodiment, in response to receiving the active request from the user, the manner in which the prompt information is sent to the user may be, for example, in the form of a pop-up window in which the prompt information may be presented in text. Additionally, the pop-up window may also carry a selection control for the user to select “agree” or “disagree” to determine whether to provide personal information to the electronic device.

It is to be understood that the preceding process of notifying the user and obtaining authorization from the user is illustrative only and does not limit the embodiments of the present disclosure, and that other manners complying with relevant laws and regulations may also be applied to the embodiments of the present disclosure.

It is to be understood that the data involved in the technical solution (including but not limited to the data itself, acquisition or use of the data) should comply with the requirements of corresponding laws, regulations and relevant rules.

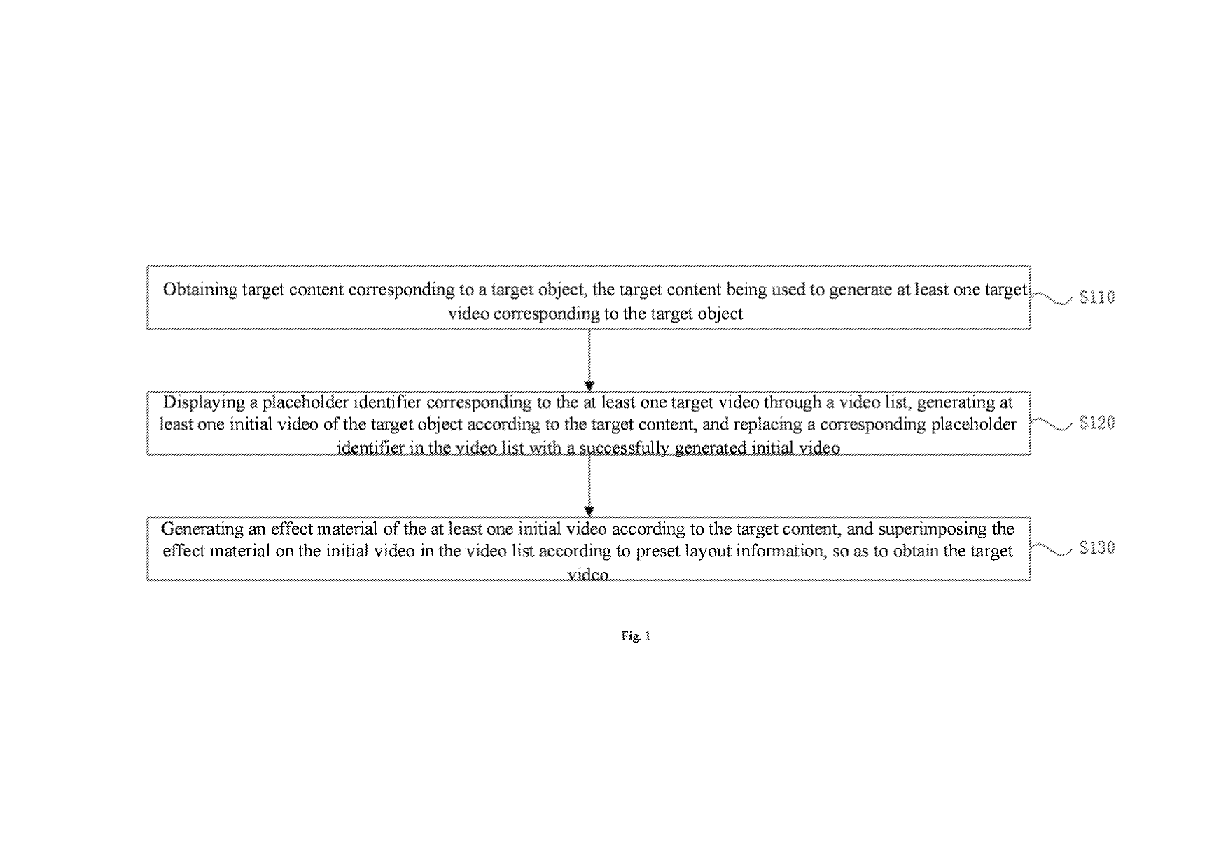

FIG. 1 is a schematic flowchart of a video list processing method provided by an embodiment of the present disclosure. The embodiment of the present disclosure is applicable to the case of generating a video list, for example, a scenario of generating a video list of a product explanation video. The method can be executed by a video list processing apparatus. The apparatus can be implemented in the form of software and/or hardware, or alternatively, can be implemented by an electronic device. The electronic device can be a mobile terminal, a PC terminal or a server, etc.

As shown in FIG. 1, the method includes:

S110: Obtaining target content corresponding to a target object, the target content being used to generate at least one target video corresponding to the target object.

The target object can represent any object in a video. The video can be a short video or a video of any other type. For example, in the e-commerce scenario, the target object can be a product, a service or a tourist attraction, etc. The target content can refer to the content associated with the target object. Specifically, the target content includes target object information and a target object attribute. The target object information represents characterizing the target object from the object content dimension. For example, the target object information can include an object image and an object introduction text, etc. The target object attribute represents characterizing the target object from the object attribute dimension. The target object attribute can include an object type or an object feature, etc.

In the embodiment of the present disclosure, the target content can include product information, service information or tourist attraction information, etc. The product information can be obtained through a product link or a product details page, etc. Similarly, the service information can be obtained through a service link or a service details page, etc. The target video can represent a video generated for the target object. For example, the target video can be an explanation video of the target object. Usually, the target video has the nature of marketing, which can show the characteristics of the target object in multiple aspects, dimensions and viewing-angles to attract the user to purchase.

Illustratively, the obtaining target content corresponding to a target object includes: obtaining a target page corresponding to the target object according to a target web address; parsing the target page to obtain the target content. The target page can represent a web page that carries the target content of the target object. In some embodiments, the target web address is obtained through the user interaction page, and if a generation operation on the user interaction page is detected, a corresponding target page is obtained according to the target web address. The target page is parsed to obtain the target content. For example, the web address, entered on the user interaction page, of product A on the e-commerce platform a is obtained, a corresponding target page is obtained according to the web address of product A, and the target page is parsed to obtain the name, selling point information and pictures, etc., of product A. The selling point information is usually the characteristics of product A, or the attribute information of other products, etc.

S120: Displaying a placeholder identifier corresponding to the at least one target video through a video list, generating at least one initial video of the target object according to the target content, and replacing a corresponding placeholder identifier in the video list with a successfully generated initial video.

The video list is a display list of generated videos. The video list is used to display at least one target video generated for the target object. Optionally, a placeholder identifier can be displayed in the video list firstly, so as to indicate the display position of each target video. The placeholder identifier can be the layout of the target video. For example, the placeholder identifier can be a rectangular pattern, etc., which is not specifically limited by the embodiment of the present disclosure. The initial video can be a video synthesized through steps such as material matching, cover interception and title extraction, etc., based on the target content. The material matching can mean selecting image content from the target content as the material needed for video synthesis. The cover interception can represent the operation of generating a video cover by combining the material and preset cover layout information. The title extraction can represent the operation of generating a video title based on the selling point or promotion information, etc., of the target object in the target content.

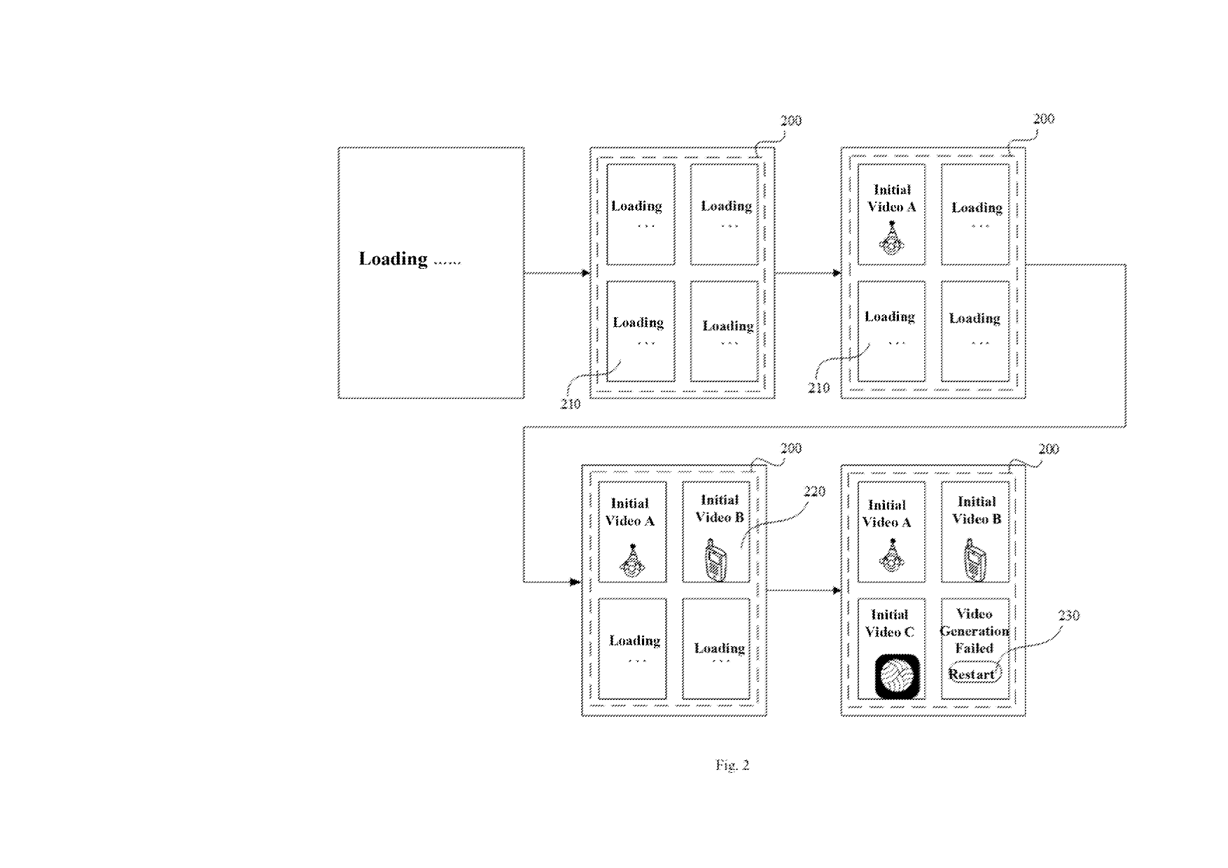

If the user enters the target web address on the user interaction page and clicks a generate button, the video list will be displayed on the user interaction page. The video list includes the placeholder identifier corresponding to at least one target video, which can indicate the display position of each target video. FIG. 2 is a schematic diagram of a video list provided by an embodiment of the present disclosure. As shown in FIG. 2, the placeholder identifiers 210 corresponding to four target videos are displayed in the video list 200, and the prompt information of being loading is displayed at the positions corresponding to the placeholder identifiers 210.

It should be noted that in an initial stage, no initial video is successfully generated, so the prompt information of being loading can be only displayed through the user interaction page. If any initial video is successfully generated, the initial video and the placeholder identifiers corresponding to other target videos are displayed through the video list.

Optionally, when no initial video is successfully generated, a corresponding number of placeholder identifiers can be displayed through the video list according to the number of target videos. The embodiment of the present disclosure is not specifically limited thereto.

Illustratively, a target material is determined according to the target object information, and a video cover is generated according to the target material and a preset cover layout; a title script is generated according to the target object information, and a video title is generated according to the title script; at least one initial video of the target object is generated according to the target material, the video cover and the video title. The corresponding placeholder identifier in the video list is replaced with the successfully generated initial video.

In the embodiment of the present disclosure, the target object information can represent the content of the target object. The target material can represent the material used to generate a video. The material includes images and text, etc. In the e-commerce scenario, the target material can include a product main graph, a product detail graph, a product selling point graph and a product scene graph, etc. The video cover can be generated according to the preset cover layout and the matched material. Optionally, a video frame that can accurately reflect the video content and video title can be extracted from a video cover set as a video cover. The video cover set includes candidate video frames, which may be used as video covers, intercepted from the initial video at fixed time points.

The video title is used to reflect the content conveyed by the video, so as to help the user quickly understand the video. The title script can represent scripts with different focuses of the target object generated based on the target object information. The focuses include promotion or selling points, etc. Because the title scripts with different focuses represent the target object from different dimensions, a title script with a certain focus can be determined according to the central idea or core of the initial video. Then, a video title is generated based on the content of the title script.

Because the generation of the target video has to go through the steps of material matching, subtitle generation, virtual object superimposition, cover interception, title extraction and video synthesis, the above process takes a long time. And only after all the target videos in the video list are generated, will the video list be displayed. The video list includes several target videos, and it is easy to block the display of the video list by a single target video with slow processing. If a video list with ten target videos is taken as an example, the above video generation process takes about one and a half minutes, and the user needs to wait for the above video generation process to be completed, and other operations cannot be performed during the process, resulting in poor user experience. Through analysis, it can be seen that the time-consuming operations in the above video generation process include subtitle generation and virtual object superimposition. Therefore, the time-consuming subtitle generation and virtual object superimposition can be extracted from the above video generation process, and video synthesis can be performed immediately after material matching, cover interception and title extraction, so as to obtain an initial video. Then, the initial video is rendered to the video list, so as to replace the corresponding placeholder identifier in the video list with the initial video. As shown in FIG. 2, after an initial video A corresponding to the placeholder identifier 210 on the upper left corner of the video list 200 is successfully generated, the placeholder identifier 210 is replaced by the initial video A to display the video cover 220 of the initial video A in the video list, and other placeholder identifiers 210 are used to display the prompt information of being generated. At this time, the initial video A may not include an effect material. If an initial video B corresponding to another placeholder identifier 210 is successfully generated, the corresponding placeholder identifier 210 is replaced by the newly generated initial video B.

Optionally, in response to an interactive operation on the initial video displayed in the video list, the initial video is played. As long as the initial video is displayed in the video list, the user can click on the initial video to view the video generation effect.

S130: Generating an effect material of the at least one initial video according to the target content, and superimposing the effect material on the initial video in the video list according to preset layout information, so as to obtain the target video.

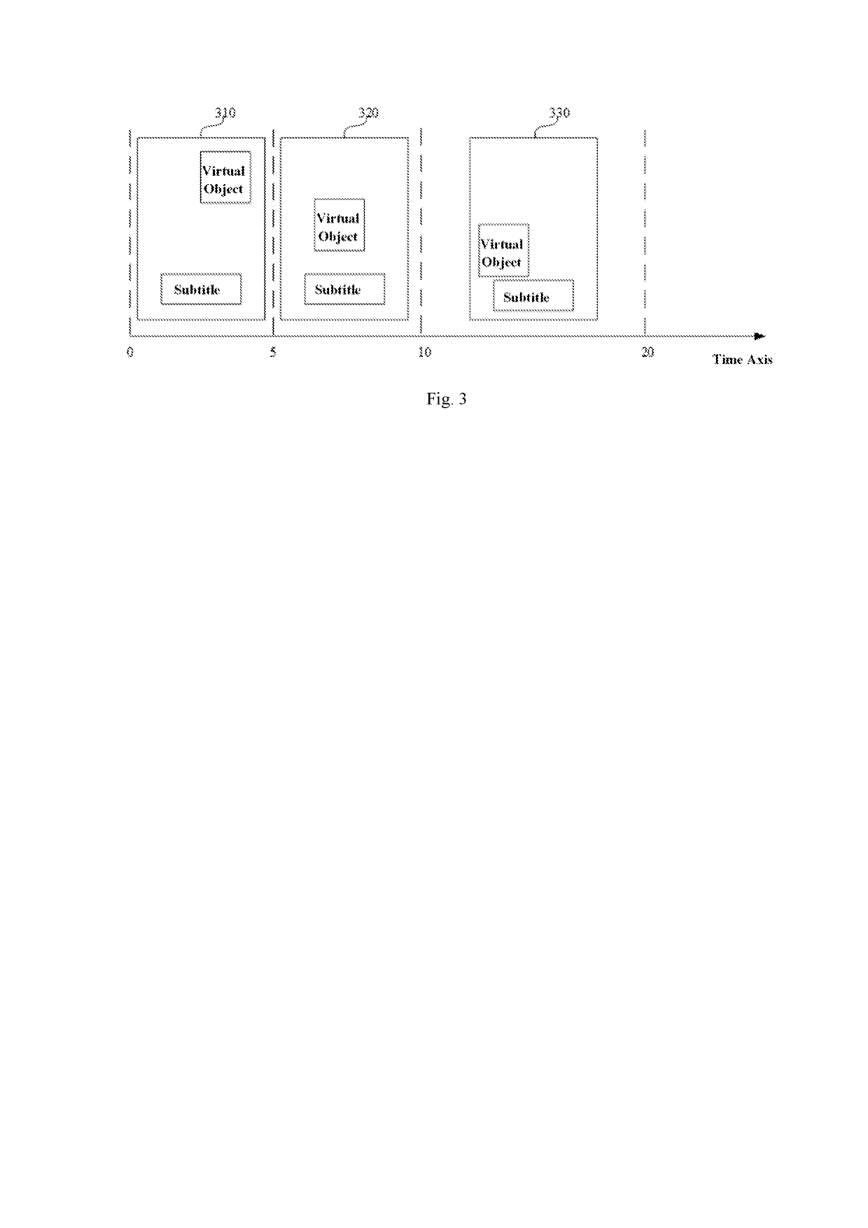

The effect material can be a processing result of the step with a time consumption meeting a preset time condition in the generation process of the target video. In the embodiment of the present disclosure, the effect material includes a subtitle generated in the subtitle generation step and/or the virtual object generated in the virtual object matching step. The virtual object can represent an object in a video for explaining a target object. For example, the virtual object can include a digital person or a virtual cartoon character, etc. The preset layout information represents the layout of the effect material in the video. Specifically, the preset layout information includes a subtitle position, a subtitle style, virtual object position information and virtual object timestamp information, etc. For example, the preset layout information can include a subtitle position, a subtitle color, a font, a background color, a virtual object position and virtual object timestamp information, etc. FIG. 3 is a schematic diagram of preset layout information provided by an embodiment of the present disclosure. As shown in FIG. 3, the layout information of each video frame can be defined based on the time axis, including: a first-type layout style 310 for 0-5 seconds, a second-type layout style 320 for 6-10 seconds, a third-type layout style 330 for 10-20 seconds, and so on.

Because the initial video has already been generated and displayed in the video list, if the subtitle and/or virtual object of any initial video are generated, they will be superimposed on the corresponding initial video in the form of plug-ins, so as to realize progressive enhancement. At this time, the target video can include the subtitle and/or virtual object. For example, the target video can be a product explanation video including a subtitle and a digital person.

Illustratively, an object character and an object audio track of the virtual object are determined according to the target object attribute, and a virtual object of the initial video is generated according to the object character and the object audio track; a subtitle script is generated according to the target object information, and subtitle content and subtitle timestamp information are generated according to the subtitle script and the object audio track, the subtitle timestamp information represents a timestamp of an initial video frame corresponding to the subtitle content. The virtual object is used to explain the target object, and the explanation content is consistent with the subtitle content. For example, in the e-commerce scenario, products are explained by a digital person. Alternatively, in the game explanation scenario, the game is explained by a digital person.

A subtitle position, a subtitle style, virtual object position information and virtual object timestamp information in the initial video are determined according to the preset layout information; the virtual object is superimposed on the initial video in the video list according to the virtual object position information and the virtual object timestamp information; a subtitle is generated according to the subtitle content and the subtitle style, and the subtitle is superimposed on the initial video in the video list according to the subtitle position and the subtitle timestamp information.

In some embodiments, an object character is matched from candidate digital persons according to the attribute of the product. For example, if the product is product X, a digital person with a character of C consistent with product X can be matched. Then, an object audio track is matched from candidate audio tracks according to the digital person with the character of C. Because the audio track can reflect the audio playback speed, if the subtitle content is determined, the playback time required to complete playing the subtitle content can be determined based on the target audio track. Optionally, an object character can also be matched from the candidate digital persons according to the product type. For example, if product X is a product of beauty type, a digital person with a character is matched from the candidate digital persons. If product X is a kitchen product, a digital person with another character is matched from the candidate digital persons.

In some embodiments, the subtitle script can represent different types of subtitle content. The subtitle script can be generated based on the target object information and a preset template. The preset template can be set based on the product explanation content commonly used. According to the video title, the subtitle content corresponding to the video of a corresponding type is determined from different types of subtitle scripts. For example, a promotion-type video needs promotional subtitles. Alternatively, a video of a type introducing product selling points needs introduction subtitles of product selling points, etc. After the subtitle content is determined, the word count of the subtitle content can be obtained. The subtitle broadcasting speed (e.g., the number of words broadcast per unit time) of the virtual object is determined based on the object audio track. The playback duration of the subtitle content is determined by combining the word count of the subtitle content and the subtitle broadcasting speed. Then, according to the video duration of the initial video corresponding to the effect material and the playback duration of the subtitle content, the subtitle timestamp information is determined.

In some embodiments, the subtitle position information includes the position information of the subtitle relative to the video, including the top distance and the left distance, and is used to position the subtitle. The subtitle style includes subtitle meta-information, etc. The subtitle meta-information includes information for rendering a subtitle, such as subtitle color, subtitle background color or font, etc. Optionally, the corresponding subtitle position and subtitle style can be matched from the candidate subtitle layouts according to the target object information and the target object attribute. Alternatively, the subtitle positions and subtitle styles corresponding to different types of target objects can be matched according to different video titles. The present disclosure is not specifically limited thereto. The virtual object layout includes virtual object position information and virtual object timestamp information. For example, the virtual object position information and virtual object timestamp information are matched from the candidate virtual object layouts according to different video titles.

According to the technical solution of the embodiment of the present disclosure, the target content of the target object is obtained for generating at least one target video corresponding to the target object; the placeholder identifier corresponding to the at least one target video is displayed through the video list; at least one initial video of the target object is firstly generated according to the target content, and a corresponding placeholder identifier in the video list is replaced by the successfully generated initial video, which can avoid the problem of blocking the display of the entire video list due to a single slowly-generated video, and shorten the time consumption from video generation to video visibility. In the process of generating and displaying the initial video, concurrently, the effect material of at least one initial video is generated according to the target content, and the successfully generated effect material is superimposed on the initial video according to the preset layout information, so as to obtain the target video. In the embodiment of the present disclosure, an initial video without the effect material is firstly generated, and the initial video is displayed in a video list, and then the successfully generated effect material is superimposed on the initial video in the form of plug-in, so as to realize progressive enhancement.

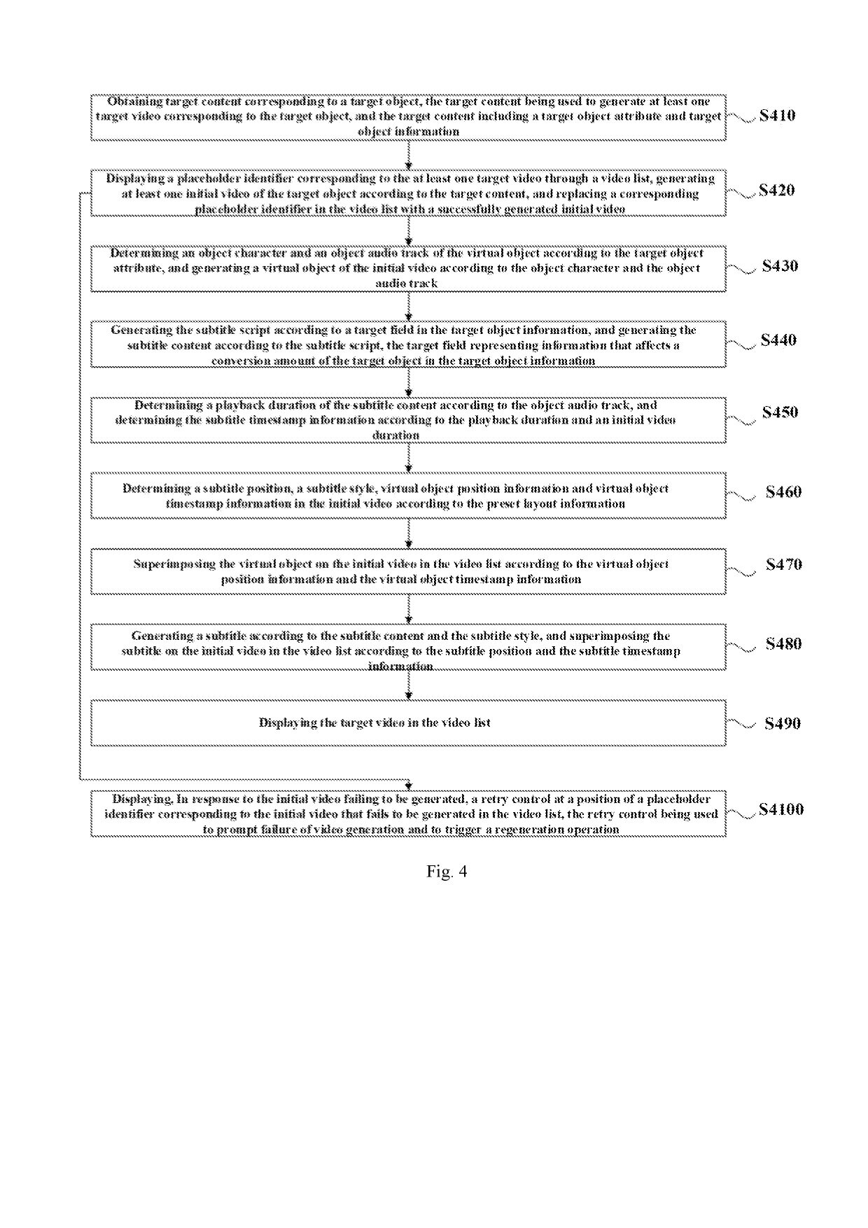

FIG. 4 is a schematic flowchart of another video list processing method provided by an embodiment of the present disclosure, which further defines the processing flow of the effect material on the basis of the above embodiments. As shown in FIG. 4, the method includes:

S410: Obtaining target content corresponding to a target object, the target content being used to generate at least one target video corresponding to the target object, and the target content including a target object attribute and target object information.

S420: Displaying a placeholder identifier corresponding to the at least one target video through a video list, generating at least one initial video of the target object according to the target content, and replacing a corresponding placeholder identifier in the video list with a successfully generated initial video.

S430: Determining an object character and an object audio track of the virtual object according to the target object attribute, and generating a virtual object of the initial video according to the object character and the object audio track.

Illustratively, a candidate virtual character is matched according to the target object attribute, so as to obtain the object character of the virtual object of the initial video. A candidate object audio track is matched according to the object character, so as to obtain the object audio track of the virtual object.

Multiple candidate virtual characters are defined in advance, and then an object character of the virtual object is matched from the candidate virtual objects according to the target object attribute. Specifically, an object character of the virtual object is matched from the candidate virtual characters according to the product type. For example, if the product is an eraser, the product type can be determined to be stationery, and a student character can be matched from the candidate characters as the object character.

According to the object character, a candidate object audio track is matched to obtain the object audio track of the virtual object, and information such as timbre, volume and playback speed, etc., can be determined based on the object audio track of the virtual object.

S440: Generating the subtitle script according to a target field in the target object information, and generating the subtitle content according to the subtitle script, the target field representing information that affects a conversion amount of the target object in the target object information.

In the embodiment of the present disclosure, the subtitle script can include different types of product explanation text, including product explanation text that uses the first person to commerce, or explanation text that uses the third person to explain the product, etc. The selling point explanation formulaic expression and the product selling point fields in the target object information can be combined to generate a subtitle script about selling point explanation. Then, the subtitle content is extracted from the subtitle script about selling point explanation. Optionally, the promotion formulaic expression and the product promotion fields in the target object information can be combined to generate a subtitle script about promotion explanation, etc. Then, the subtitle content is extracted from the subtitle script about promotion explanation.

S450: Determining a playback duration of the subtitle content according to the object audio track, and determining the subtitle timestamp information according to the playback duration and an initial video duration.

The number of words that can be broadcast per unit time can be determined based on the target audio track and the subtitle content, and then the playback duration of the subtitle content can be determined based on the subtitle content and the number of words broadcast per unit time. Because the broadcast of the subtitle should be completed when the playback of the video is completed, the timestamp of the initial video frame corresponding to the subtitle content can be determined according to the playback duration of the subtitle content and the initial video duration.

S460: Determining a subtitle position, a subtitle style, virtual object position information and virtual object timestamp information in the initial video according to the preset layout information.

S470: Superimposing the virtual object on the initial video in the video list according to the virtual object position information and the virtual object timestamp information.

S480: Generating a subtitle according to the subtitle content and the subtitle style, and superimposing the subtitle on the initial video in the video list according to the subtitle position and the subtitle timestamp information.

Because the display position of each target video in the video list is represented by a placeholder identifier, if the initial video at a certain position is successfully generated, the placeholder identifier at that position is replaced by the successfully generated initial video. Then, if the effect material corresponding to any initial video in the video list has been rendered, the effect material is superimposed on the initial video in the form of plug-in, so as to complete progressive enhancement.

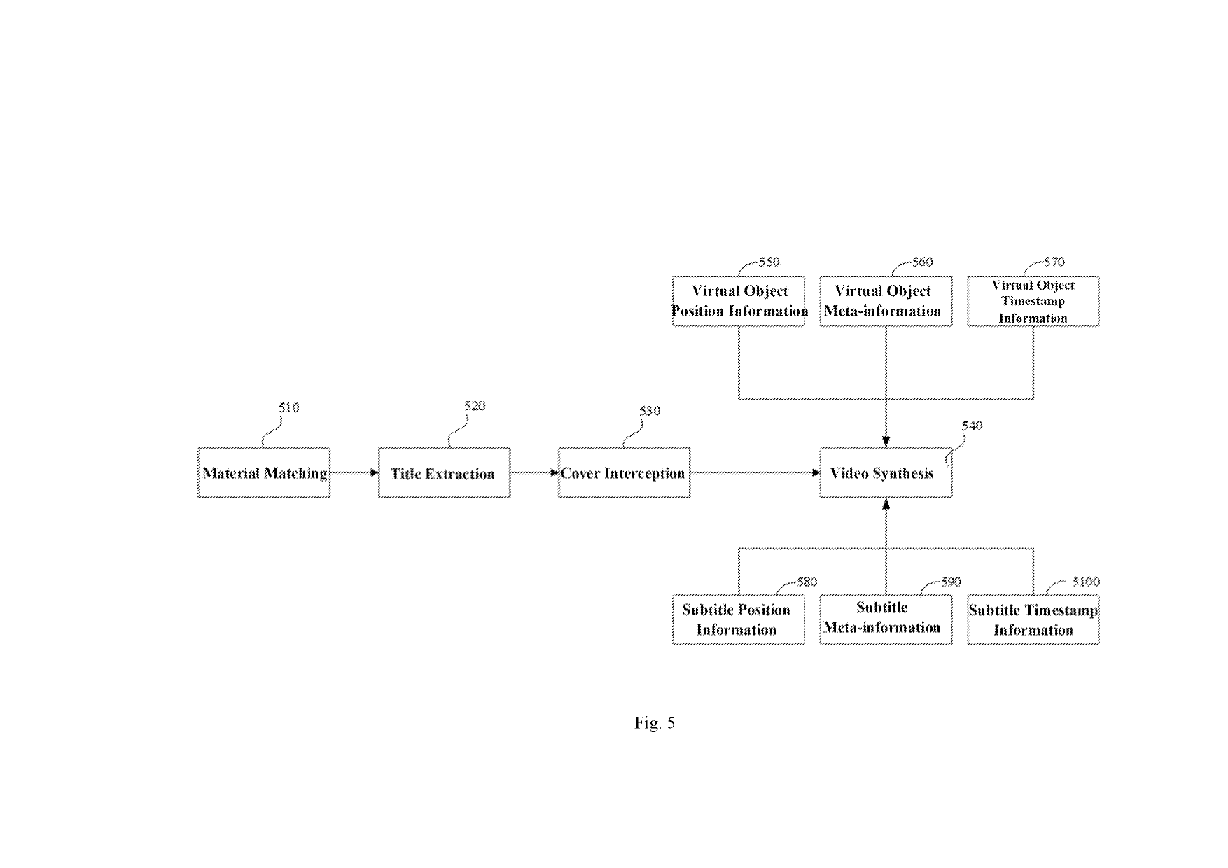

FIG. 5 is a schematic diagram of a video rendering process provided by an embodiment of the present disclosure. During the video rendering process, the subtitle generation and virtual object superimposition processes are time-consuming. As shown in FIG. 5, material matching 510, title extraction 520 and cover interception 530 can be performed firstly, and video synthesis 540 can be performed immediately after the completion of material matching, title extraction and cover interception, so as to obtain an initial video and render it to the video list. In this process, the subtitle generation and virtual object matching steps continue to be executed, so that virtual object position information 550, virtual object meta-information 560 and virtual object timestamp information 570 are determined, and the virtual object is rendered based on the virtual object meta-information 560; and subtitle position information 580, subtitle meta-information 590 and subtitle timestamp information 5100 are determined, and the subtitle content is rendered based on the subtitle meta-information 590. If the virtual object corresponding to the initial video has been rendered, the rendered virtual object is superimposed on the corresponding video frame of the initial video in the video list according to the virtual object position information 550 and the virtual object timestamp information 570. If the subtitle corresponding to the initial video has been rendered, the rendered subtitle is superimposed on the corresponding video frame of the initial video in the video list according to the subtitle position and subtitle timestamp information.

The subtitle meta-information includes subtitle content, color, background color, font, etc., and is used to render the subtitle content. The subtitle position information refers to the position information of the subtitle relative to the video frame, including the top distance and the left distance, and is used to position the subtitle. The subtitle timestamp information refers to a video timestamp corresponding to the current subtitle content, and is used to decide when to render this subtitle. The virtual object meta-information includes an object character and an object audio track, and is used to render the virtual object. The virtual object position information refers to position information of the virtual object relative to the video frame, including the top distance and the left distance, and is used to position the virtual object. The virtual object timestamp information refers to a video timestamp corresponding to the current virtual object, and is used to decide when to render this virtual object.

S490: Displaying the target video in the video list.

S4100: Displaying, in response to the initial video failing to be generated, a retry control at a position of a placeholder identifier corresponding to the initial video that fails to be generated in the video list, the retry control being used to prompt failure of video generation and to trigger a regeneration operation.

Referring to FIG. 2, in the initial stage, all videos are in the synthesis state, and the user interaction page shows the prompt information of being loading. If any initial video is successfully synthesized, the successfully synthesized initial video is displayed through the video list 200, and other videos that are not successfully synthesized are displayed with placeholder identifiers 210. The synthesis status of videos that are not successfully synthesized is detected in real time, and when a new initial video is successfully synthesized, this initial video is used to replace the placeholder identifier 210 at the corresponding position in the video list 200. If the video fails to be synthesized, a retry control 230 is displayed at the position of the corresponding placeholder identifier 210.

According to the technical solution of the embodiment of the present disclosure, the less time-consuming processes of material matching, title extraction and cover interception in the video rendering process are extracted, the initial video is synthesized after the completion of material matching, title extraction and cover interception, and the initial video is rendered to the video list for display, so that the time-consumption of video visibility can be shortened. In the above process, concurrently, the time-consuming subtitle rendering process and virtual object rendering process are executed, and the subtitle and virtual object are superimposed on the corresponding initial video in the video list after the rendering of the subtitle and virtual object are completed,, so that the video in the video list is gradually enhanced during the video generation process.

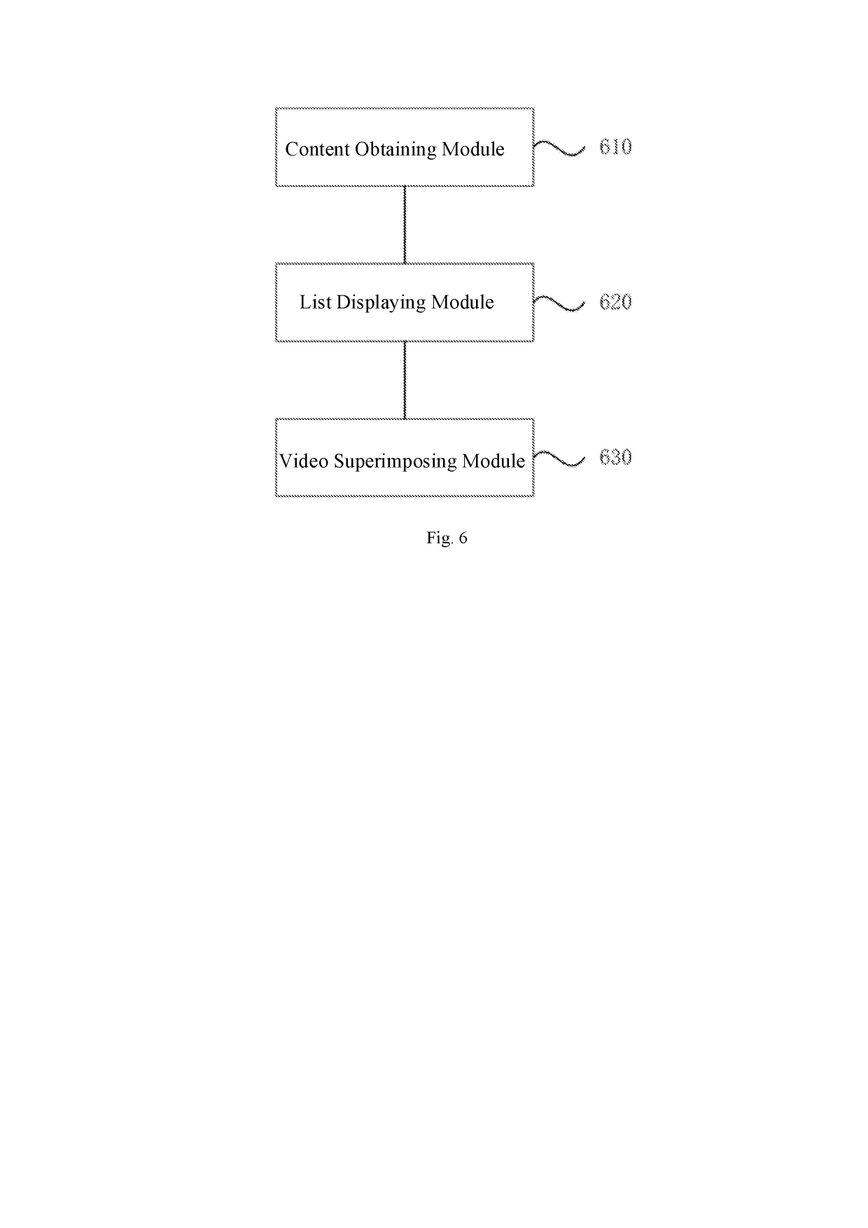

FIG. 6 is a schematic structural diagram of a video list processing apparatus provided by an embodiment of the present disclosure. The apparatus can be implemented in the form of software and/or hardware, or alternatively, can be implemented by an electronic device. The electronic device can be a mobile terminal, a PC terminal or a server, etc.

As shown in FIG. 6, the apparatus includes a content obtaining module 610, a list displaying module 620 and a video superimposing module 630.

The content obtaining module 610 is configured to obtain target content corresponding to a target object, the target content being used to generate at least one target video corresponding to the target object;

the list displaying module 620 is configured to display a placeholder identifier corresponding to the at least one target video through a video list, generate at least one initial video of the target object according to the target content, and replace a corresponding placeholder identifier in the video list with a successfully generated initial video;

the video superimposing module 630 is configured to generate an effect material of the at least one initial video according to the target content, and superimpose the effect material on the initial video in the video list according to preset layout information, so as to obtain the target video.

Optionally, the content obtaining module 610 is specifically configured to:

obtain a target page corresponding to the target object according to a target web address;

parse the target page to obtain the target content.

Optionally, the target content includes target object information;

the list displaying module 620 is specifically configured to:

determine a target material according to the target object information, and generate a video cover according to the target material and a preset cover layout;

generate a title script according to the target object information, and generate a video title according to the title script;

generate the at least one initial video of the target object according to the target material, the video cover and the video title.

Optionally, the target content includes a target object attribute and target object information; the effect material includes a virtual object and a subtitle;

the video superimposing module 630 is specifically configured to:

determine an object character and an object audio track of the virtual object according to the target object attribute, and generate a virtual object of the initial video according to the object character and the object audio track;

generate a subtitle script according to the target object information, and generate subtitle content and subtitle timestamp information according to the subtitle script and the object audio track, the subtitle timestamp information representing a timestamp of an initial video frame corresponding to the subtitle content.

Further, generating a subtitle script according to the target object information, and generating subtitle content and subtitle timestamp information according to the subtitle script and the object audio track, includes:

generating the subtitle script according to a target field in the target object information, and generating the subtitle content according to the subtitle script, the target field representing information that affects a conversion amount of the target object in the target object information;

determining a playback duration of the subtitle content according to the object audio track, and determining the subtitle timestamp information according to the playback duration and an initial video duration.

Further, the video superimposing module 630 is specifically configured to:

determine a subtitle position, a subtitle style, virtual object position information and virtual object timestamp information in the initial video according to the preset layout information;

superimpose the virtual object on the initial video in the video list according to the virtual object position information and the virtual object timestamp information;

generate a subtitle according to the subtitle content and the subtitle style, and superimpose the subtitle on the initial video in the video list according to the subtitle position and the subtitle timestamp information.

Optionally, the apparatus further includes:

a failure retry module, configured to display, in response to the initial video failing to be generated, a retry control at a position of a placeholder identifier corresponding to the initial video that fails to be generated in the video list, the retry control being used to prompt failure of video generation and to trigger a regeneration operation.

Optionally, the apparatus further includes:

a video playing module, configured to play, in response to an interactive operation on the initial video displayed in the video list, the initial video.

The video list processing apparatus provided by the embodiment of the present disclosure can execute the video list processing method provided by any embodiment of the present disclosure, and has corresponding functional modules for executing the method and corresponding beneficial effects.

It is to be noted that units and modules included in the preceding apparatus are just divided according to functional logic, and the division is not limited thereto, as long as the corresponding functions can be implemented. Additionally, the specific names of the units and modules are just intended for distinguishing, and are not intended to limit the protection scope of the embodiments of the present disclosure.

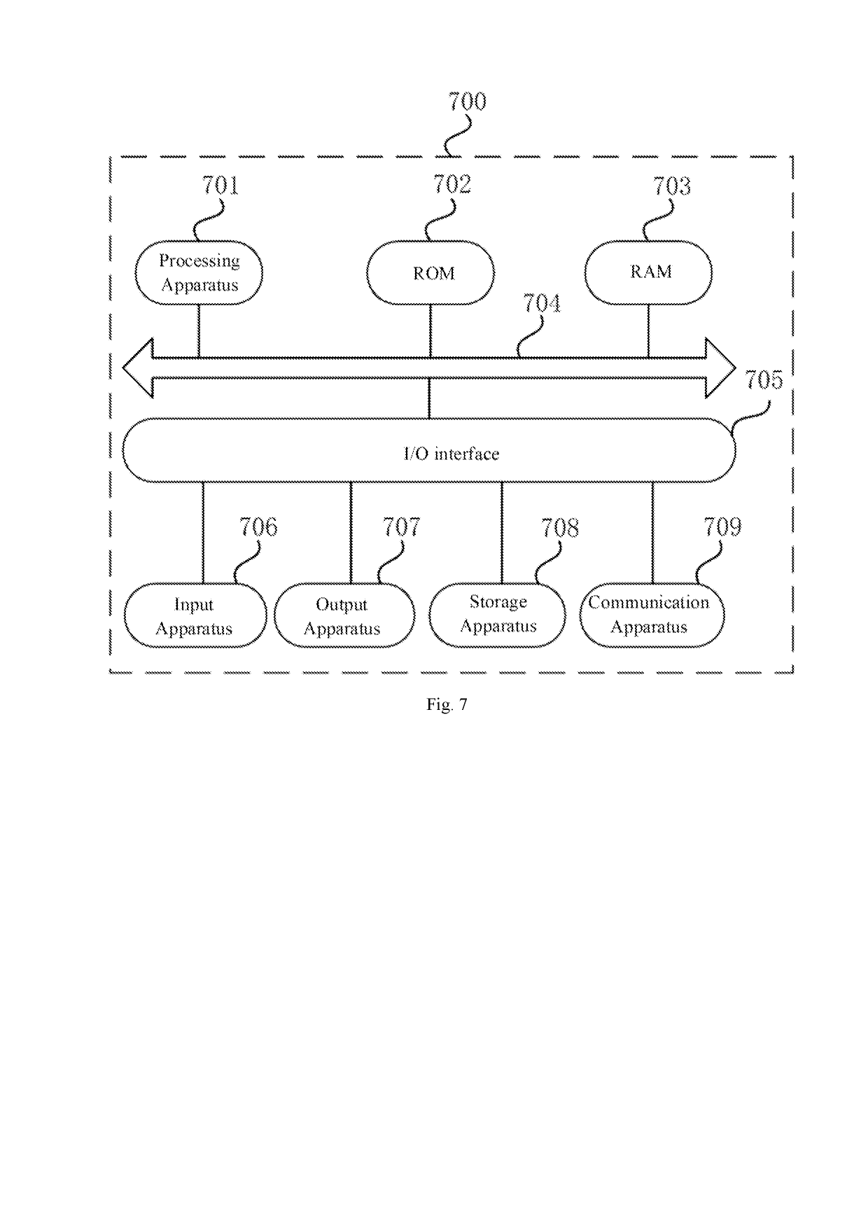

FIG. 7 is a schematic structural diagram of an electronic device provided by an embodiment of the present disclosure. Hereinafter, referring to FIG. 7, it shows a schematic structural diagram of an electronic device 700 (e.g., a terminal device or a server in FIG. 7) suitable for implementing the embodiment of the present disclosure. The terminal device in the embodiment of the present disclosure can include, but is not limited to, a mobile terminal such as a mobile phone, a laptop computer, a digital broadcast receiver, a personal digital assistant (PDA), a portable android device (PAD), a portable media player (PMP), a vehicle-mounted terminal (e.g., vehicle-mounted navigation terminal), etc., and a fixed terminal such as a digital television (TV), a desktop computer, etc. The electronic device shown in FIG. 7 is merely an example, and should not bring any limitation to the function and application scope of the embodiment of the present disclosure.

As shown in FIG. 7, the electronic device 700 can include a processing apparatus (e.g., central processing unit, graphics processing unit, etc.) 701, which can execute various suitable actions and processes according to a program stored in a read-only memory (ROM) 702 or a program loaded from a storage apparatus 708 into a random access memory (RAM) 703. In the RAM 703, various programs and data necessary for the operations of the electronic device 700 are also stored. The processing apparatus 701, the ROM 702, and the RAM 703 are connected to each other through a bus line 704. An input/output (I/O) interface 705 is also connected to the bus line 704.

Generally, the following apparatuses can be connected to the I/O interface 705: an input apparatus 706 including, for example, a touch screen, a touch pad, a keyboard, a mouse, a camera, a microphone, an accelerometer, a gyroscope, etc.; an output apparatus 707 including, for example, a liquid crystal display (LCD), a speaker, a vibrator, etc.; a storage apparatus 708 including, for example, a magnetic tape, a hard disk, etc.; and a communication apparatus 709. The communication apparatus 709 can allow the electronic device 700 to perform wireless or wired communication with another device to exchange data. While FIG. 7 illustrates the electronic device 700 with various apparatuses, it should be understood that all illustrated apparatuses are not required to be implemented or provided. More or fewer apparatuses can be alternatively implemented or provided.

In particular, according to the embodiment of the present disclosure, the process described above with reference to the flowcharts can be implemented as a computer software program. For example, an embodiment of the present disclosure provides a computer program product including a computer program carried on a non-transitory computer-readable medium, and the computer program contains program codes for performing the method illustrated by the flowcharts. In such an embodiment, the computer program can be downloaded and installed from a network via the communication apparatus 709, or installed from the storage apparatus 708, or installed from the ROM 702. When executed by the processing apparatus 701, the computer program performs the above functions defined in the method according to the embodiment of the present disclosure.

Names of messages or information exchanged among multiple apparatuses in the embodiments of the present disclosure are merely used for illustrative purposes, and are not used to limit the scope of these messages or information.

The electronic device provided by the embodiment of the present disclosure belongs to the same inventive concept as the video list processing method provided by the above embodiments, and the technical details not provided in the present embodiment can be found in the above embodiments, and the present embodiment has the same beneficial effects as the above embodiment.

An embodiment of the present disclosure provides a computer storage medium, on which a computer program is stored; when the computer program is executed by a processor, the video list processing method provided by the above embodiments is implemented.

It should be noted that the above computer-readable medium of the present disclosure can be a computer-readable signal medium or a computer-readable storage medium or any combination thereof. The computer-readable storage medium can be, for example, but not limited to, an electronic, magnetic, optical, electromagnetic, infrared, or semiconductor system, apparatus, or device, or any combination of the above. More specific examples of the computer-readable storage medium can include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium can be any tangible medium containing or storing a program, the program can be used by or in conjunction with an instruction execution system, apparatus, or device. In the present disclosure, the computer-readable signal medium can include a data signal propagated in baseband or as part of a carrier wave, in which computer-readable program code is carried. Such a propagated data signal can take a variety of forms, including but not limited to an electro-magnetic signal, an optical signal, or any suitable combination of the above. The computer-readable signal medium can be any computer-readable medium other than the computer-readable storage medium, and the computer-readable signal medium can send, propagate, or transmit a program for use by or in conjunction with an instruction execution system, apparatus, or device. Program codes contained on the computer-readable medium can be transmitted using any suitable medium, including but not limited to: an electrical wire, an optical cable, radio frequency (RF), etc., or any suitable combination of the above.

In some implementations, a client and a server can communicate using any currently known or future developed network protocol, such as Hyper Text Transfer Protocol (HTTP), etc., and can be interconnected with any form or medium of digital data communication (e.g., a communication network). Examples of the communication network include a local area network (“LAN”), a wide area network (“WAN”), an internet (e.g., the Internet), and an end-to-end network (e.g., ad hoc end-to-end network), as well as any currently known or future developed network.

The computer-readable medium may be contained in the above electronic device; or may also exist alone without being assembled into the electronic device.

The above computer-readable medium has thereon carried one or more programs which, when executed by the electronic device, cause the electronic device to:

obtain target content corresponding to a target object, the target content being used to generate at least one target video corresponding to the target object;

display a placeholder identifier corresponding to the at least one target video through a video list, generate at least one initial video of the target object according to the target content, and replace a corresponding placeholder identifier in the video list with a successfully generated initial video;

generate an effect material of the at least one initial video according to the target content, and superimpose the effect material on the initial video in the video list according to preset layout information, so as to obtain the target video.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user’s computer, partly on the user’s computer, as a stand-alone software package, partly on the user’s computer and partly on a remote computer, or entirely on the remote computer or server. In the scenario related to the remote computer, the remote computer may be connected to the user’s computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A video list processing method, comprising:
obtaining target content corresponding to a target object, wherein the target content is used to generate at least one target video corresponding to the target object;
displaying a placeholder identifier corresponding to the at least one target video through a video list, generating at least one initial video of the target object according to the target content, and replacing a corresponding placeholder identifier in the video list with a successfully generated initial video; and
generating an effect material of the at least one initial video according to the target content, and superimposing the effect material on the initial video in the video list according to preset layout information, so as to obtain the target video.

2. The method according to claim 1, wherein the obtaining target content corresponding to a target object comprises:
obtaining a target page corresponding to the target object according to a target web address; and
parsing the target page to obtain the target content.

3. The method according to claim 1, wherein the target content comprises target object information;
the generating at least one initial video of the target object according to the target content, and replacing a corresponding placeholder identifier in the video list with a successfully generated initial video, comprises:
determining a target material according to the target object information, and generating a video cover according to the target material and a preset cover layout;
generating a title script according to the target object information, and generating a video title according to the title script; and
generating the at least one initial video of the target object according to the target material, the video cover and the video title.

4. The method according to claim 1, wherein the target content comprises a target object attribute and target object information; the effect material comprises a virtual object and a subtitle;
the generating an effect material of the at least one initial video according to the target content comprises:
determining an object character and an object audio track of the virtual object according to the target object attribute, and generating a virtual object of the initial video according to the object character and the object audio track; and
generating a subtitle script according to the target object information, and generating subtitle content and subtitle timestamp information according to the subtitle script and the object audio track, wherein the subtitle timestamp information represents a timestamp of an initial video frame corresponding to the subtitle content.

5. The method according to claim 4, wherein the generating a subtitle script according to the target object information, and generating subtitle content and subtitle timestamp information according to the subtitle script and the object audio track, comprises:
generating the subtitle script according to a target field in the target object information, and generating the subtitle content according to the subtitle script, wherein the target field represents information that affects a conversion amount of the target object in the target object information; and
determining a playback duration of the subtitle content according to the object audio track, and determining the subtitle timestamp information according to the playback duration and an initial video duration.

6. The method according to claim 4, wherein the superimposing the effect material on the initial video in the video list according to preset layout information comprises:
determining a subtitle position, a subtitle style, virtual object position information and virtual object timestamp information in the initial video according to the preset layout information;
superimposing the virtual object on the initial video in the video list according to the virtual object position information and the virtual object timestamp information; and
generating a subtitle according to the subtitle content and the subtitle style, and superimposing the subtitle on the initial video in the video list according to the subtitle position and the subtitle timestamp information.

7. The method according to claim 1, further comprising:
displaying, in response to the initial video failing to be generated, a retry control at a position of a placeholder identifier corresponding to the initial video that fails to be generated in the video list, wherein the retry control is used to prompt failure of video generation and to trigger a regeneration operation.

8. The method according to claim 1, further comprising:
playing, in response to an interactive operation on the initial video displayed in the video list, the initial video.

9. An electronic device, comprising:
one or more processors;
a storage apparatus, configured to store one or more programs,
wherein, when the one or more programs are executed by the one or more processors, the one or more processors are caused to implement a video list processing method,
wherein the video list processing method comprises:
obtaining target content corresponding to a target object, wherein the target content is used to generate at least one target video corresponding to the target object;
displaying a placeholder identifier corresponding to the at least one target video through a video list, generating at least one initial video of the target object according to the target content, and replacing a corresponding placeholder identifier in the video list with a successfully generated initial video; and
generating an effect material of the at least one initial video according to the target content, and superimposing the effect material on the initial video in the video list according to preset layout information, so as to obtain the target video.

10. The electronic device according to claim 9, wherein the obtaining target content corresponding to a target object comprises:
obtaining a target page corresponding to the target object according to a target web address; and
parsing the target page to obtain the target content.

11. The electronic device according to claim 9, wherein the target content comprises target object information;
the generating at least one initial video of the target object according to the target content, and replacing a corresponding placeholder identifier in the video list with a successfully generated initial video, comprises:
determining a target material according to the target object information, and generating a video cover according to the target material and a preset cover layout;
generating a title script according to the target object information, and generating a video title according to the title script; and
generating the at least one initial video of the target object according to the target material, the video cover and the video title.

12. The electronic device according to claim 9, wherein the target content comprises a target object attribute and target object information; the effect material comprises a virtual object and a subtitle;
the generating an effect material of the at least one initial video according to the target content comprises:
determining an object character and an object audio track of the virtual object according to the target object attribute, and generating a virtual object of the initial video according to the object character and the object audio track; and
generating a subtitle script according to the target object information, and generating subtitle content and subtitle timestamp information according to the subtitle script and the object audio track, wherein the subtitle timestamp information represents a timestamp of an initial video frame corresponding to the subtitle content.

13. The electronic device according to claim 12, wherein the generating a subtitle script according to the target object information, and generating subtitle content and subtitle timestamp information according to the subtitle script and the object audio track, comprises:
generating the subtitle script according to a target field in the target object information, and generating the subtitle content according to the subtitle script, wherein the target field represents information that affects a conversion amount of the target object in the target object information; and
determining a playback duration of the subtitle content according to the object audio track, and determining the subtitle timestamp information according to the playback duration and an initial video duration.

14. The electronic device according to claim 12, wherein the superimposing the effect material on the initial video in the video list according to preset layout information comprises:
determining a subtitle position, a subtitle style, virtual object position information and virtual object timestamp information in the initial video according to the preset layout information;
superimposing the virtual object on the initial video in the video list according to the virtual object position information and the virtual object timestamp information; and
generating a subtitle according to the subtitle content and the subtitle style, and superimposing the subtitle on the initial video in the video list according to the subtitle position and the subtitle timestamp information.

15. The method according to claim 9, further comprising:
displaying, in response to the initial video failing to be generated, a retry control at a position of a placeholder identifier corresponding to the initial video that fails to be generated in the video list, wherein the retry control is used to prompt failure of video generation and to trigger a regeneration operation.

16. The method according to claim 9, further comprising:
playing, in response to an interactive operation on the initial video displayed in the video list, the initial video.

17. A non-transitory storage medium containing computer-executable instructions, wherein the computer-executable instructions, when executed by a computer processor, are used to execute a video list processing method,
wherein the video list processing method comprises:
obtaining target content corresponding to a target object, wherein the target content is used to generate at least one target video corresponding to the target object;
displaying a placeholder identifier corresponding to the at least one target video through a video list, generating at least one initial video of the target object according to the target content, and replacing a corresponding placeholder identifier in the video list with a successfully generated initial video; and
generating an effect material of the at least one initial video according to the target content, and superimposing the effect material on the initial video in the video list according to preset layout information, so as to obtain the target video.

18. The non-transitory storage medium according to claim 17, wherein the obtaining target content corresponding to a target object comprises:
obtaining a target page corresponding to the target object according to a target web address; and
parsing the target page to obtain the target content.

19. The non-transitory storage medium according to claim 17, wherein the target content comprises target object information;
the generating at least one initial video of the target object according to the target content, and replacing a corresponding placeholder identifier in the video list with a successfully generated initial video, comprises:
determining a target material according to the target object information, and generating a video cover according to the target material and a preset cover layout;
generating a title script according to the target object information, and generating a video title according to the title script; and
generating the at least one initial video of the target object according to the target material, the video cover and the video title.

20. The non-transitory storage medium according to claim 17, wherein the target content comprises a target object attribute and target object information; the effect material comprises a virtual object and a subtitle;
the generating an effect material of the at least one initial video according to the target content comprises:
determining an object character and an object audio track of the virtual object according to the target object attribute, and generating a virtual object of the initial video according to the object character and the object audio track; and
generating a subtitle script according to the target object information, and generating subtitle content and subtitle timestamp information according to the subtitle script and the object audio track, wherein the subtitle timestamp information represents a timestamp of an initial video frame corresponding to the subtitle content.
